(19) United States
(12) Patent Application Publication
(10) Pub. No.: US 2025/0284491 A1
(43) Pub. Date: Sep. 11, 2025

(54) System, Method, and Device For Managing Multi-Tenant Development Systems

(71) Applicant: The Toronto-Dominion Bank, Toronto (CA)

(72) Inventors: Ori COHEN, Vaughan (CA); Mei LU, Oakville (CA)

(73) Assignee: The Toronto-Dominion Bank, Toronto (CA)

(21) Appl. No.: 18/601,350

(22) Filed: Mar. 11, 2024

(51) Int. Cl. G06F 8/73

(52) U.S. Cl. CPC G06F 8/73

(57) ABSTRACT

A device, method, and system for managing multi-user development systems is disclosed. Illustratively, the method includes providing a platform that enables customization of objects associated with the platform through record based configurations and providing a plurality of configuration files, each configuration file associated with a distinct functionality of the platform. The method includes, for each configuration file of the plurality of the configuration files, structuring the respective configuration file to be an objected oriented and a feature-based data file for entering record based configuration changes for the respective functionality. The method includes accepting requests for customizations of objects in the platform through the plurality of configuration files.

### TECHNICAL FIELD

The following relates generally to methods of managing multi-user development systems.

### BACKGROUND

In multi-user development systems, such as enterprise development systems, a plurality of users (e.g., developers), potentially spread across multiple product or development environments, may simultaneously customize one or more objects (e.g., nCino™ objects) of a platform. The development process can include the different and sometimes disparate users proposing changes to the objects independently of one another. Incompatible of inconsistent changes to the same or interdependent objects can surface only later in these multi-user development systems. For example, a first user can propose a change, while a second user can propose a change that overrides the changes proposed by the first user. Changes by one user to a first object can unexpectedly impact another object and render changes to the other object incompatible.

That is, existing systems employ approaches which can result in conflicting modifications, violations of multiple dependencies, and version control challenges to the various different objects as different users implement or propose changes to objects of the platform. Existing approaches can negatively impact system integrity, functionality, and the velocity of program development for programs which depend on the aforementioned objects.

### BRIEF DESCRIPTION OF THE DRAWINGS

Embodiments will now be described with reference to the appended drawings wherein:

FIG. 1 is a schematic diagram of an example computing environment.

FIGS. 2A, 2B are each a diagram illustrating an existing framework for managing multi-user development systems.

FIGS. 3A, 3C, and 3D are diagrams illustrating different aspects of an example framework for managing multi-user development systems.

FIG. 3B is a diagram illustrating an existing framework for managing multi-user development systems.

FIG. 4 shows a flow diagram of an example embodiment of computer executable instructions for implementing a method for managing multi-user development systems.

FIG. 5 is a block diagram of an example configuration of an example device.

FIG. 6 is a block diagram of an example server.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

Existing implementations in record-based configuration platforms, such as nCino™, are quickly becoming unmanageable given that various users in various sandboxes or environments can implement changes to the objects of the platform.

The following describes a system that may be configured for generating object oriented and feature based configuration files for each functionality of the platform, and processing changes to objects of the platform via the configuration files. The configuration files can be JSON files that are centrally available to a plurality of environments.

The use of the object oriented and feature based configuration files can enable changes to platform objects in a streamlined manner. The configuration files, by being inserted into development environments, enable visibility of conflicts between proposed changes from different users/environments. By resolving conflicts sooner, the process of automated development can be more efficient and predictable. Central control of the configuration files enables sequential deployment and enforces version control. In addition, by forcing visibility of some of the more common conflicts issues via the configuration files, the velocity of the automation process can be increased.

In one aspect, a device for managing multi-user development systems is disclosed. The device includes a processor, a communications module coupled to the processor, and a memory coupled to the processor. The memory stores computer executable instructions that when executed by the processor cause the processor to provide a platform that enables customization of objects associated with the platform through record-based configurations and provide a plurality of configuration files, each configuration file associated with a distinct functionality of the platform. The instructions cause the processor to, for each configuration file of the plurality of the configuration files, structure the respective configuration file to be an objected oriented and a feature-based data file for entering record-based configuration changes for the respective functionality. The instructions cause the processor to accept requests for customizations of objects in the platform through the plurality of configuration files.

In example embodiments, the computer executable instructions cause the processor to provide access to the plurality of configuration files to a plurality of development environments. The access provided to the plurality of development environments can be simultaneous.

In example embodiments, the computer executable instructions cause the processor to populate new development environments with the plurality of configuration files.

In example embodiments, the plurality of configuration files are in a JSON format. The JSON format can be structured such that configuration files utilize SOQL statements to handle a specific object for a corresponding feature.

In example embodiments, the computer executable instructions cause the processor to update the plurality of configuration files in response to the conclusion of a development cycle.

In example embodiments, the computer executable instructions cause the processor to route requests to customize objects of the platform to the plurality of configuration files.

In example embodiments, the plurality of configuration files comprise configuration files for user interface functionality or for role definition functionality or product functionality.

In example embodiments, the computer executable instructions cause the processor to automatically perform one or more development operations in response to receiving requests for customizations of objects in the platform through the plurality of configuration files.

In another aspect, a method for managing multi-user development systems is disclosed. The method includes providing a platform that enables customization of objects associated with the platform through record based configurations and providing a plurality of configuration files, each configuration file associated with a distinct functionality of the platform. The method includes, for each configuration file of the plurality of the configuration files, structuring the respective configuration file to be an objected oriented and a feature-based data file for entering record based configuration changes for the respective functionality. The method includes accepting requests for customizations of objects in the platform through the plurality of configuration files.

In example embodiments, the method includes providing access to the plurality of configuration files to a plurality of development environments. The access provided to the plurality of development environments can be simultaneous.

In example embodiments, the method includes populating new development environments with the plurality of configuration files.

In example embodiments, the plurality of configuration files are in a JSON format. The JSON format can be structured such that configuration files utilize SOQL statements to handle a specific object for a corresponding feature.

In example embodiments, the method includes updating the plurality of configuration files in response to the conclusion of a development cycle.

In example embodiments, the method includes routing requests to customize objects of the platform to the plurality of configuration files.

In example embodiments, the plurality of configuration files comprise configuration files for user interface functionality or for role definition functionality or product functionality.

In example embodiments, the method includes automatically performing one or more development operations in response to receiving requests for customizations of objects in the platform through the plurality of configuration files.

In another aspect, a non-transitory computer readable medium for managing multi-user development systems is disclosed. The computer readable medium includes computer executable instructions for performing any one of the above noted methods.

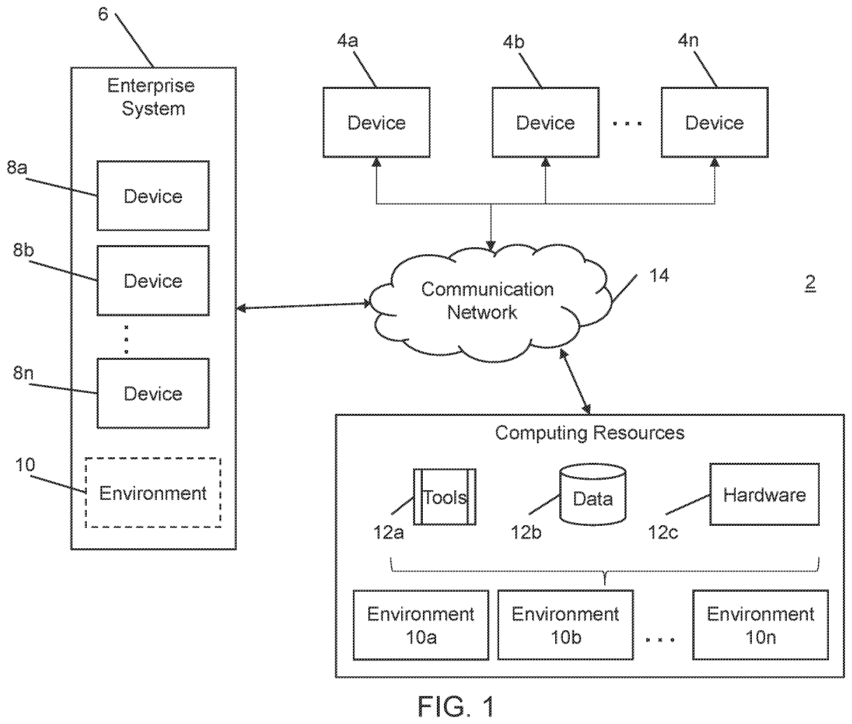

Referring now to FIG. 1, an exemplary computing environment 2 is illustrated.

In the example embodiment shown, the computing environment 2 includes one or more devices 4 (shown as devices 4a, 4b, . . . 4n), an enterprise system 6, and devices 8 (e.g., the shown devices 8a, 8b, to 8n), internal to the enterprise system 6.

The devices 4 can be external to the enterprise system 6, and can be used to access functionality of the enterprise system 6 (e.g., by an employee). Devices 4 can include, but are not limited to, one or more of a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, and any additional or alternate computing device, and may be operable to transmit and receive data across communication networks such as the communication network 14 shown by way of example in FIG. 1.

Different users can use devices 4, and with different user accounts. For example, in some embodiments, a device 4a can be internal to the enterprise system 6 (not shown) and used by an employee with a first level of access, an employee with a second level of access, etc., third party contractor, customer, etc. The user may be required to be authenticated prior to accessing the device 4, the device 4 can be required to be authenticated prior to accessing either the enterprise system 6 or the remote computing resources 12 (as described herein), or any specific accounts or resources within computing environment 2.

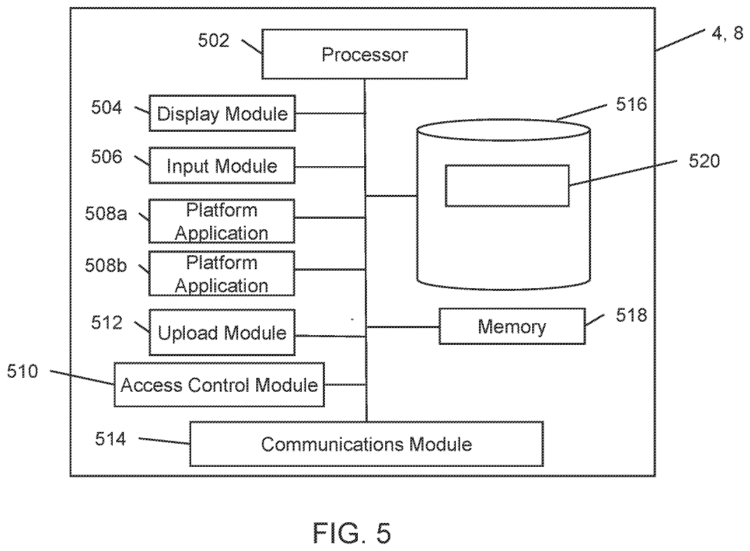

The device 4 can access information within the enterprise system 6 or remote computing resources 12 associated with the enterprise system 6 in a variety of ways. For example, the device 4 can access the at least some of the functionality of the enterprise system 6 via a web-based application, or a dedicated application (e.g., application 508a, 508b of FIG. 5), etc. Access can require the provisioning of credentials (e.g., login credentials, two factor authentication, etc.). In example embodiments, each different device 4 can be provided with a degree of access, or variations thereof. For example, the internal device 8 (as described herein) can be provided with a greater degree of access to the enterprise system 6 as compared to the external device 4.

The devices 8, internal to the enterprise system 6, can be used to implement or access (e.g., similar to devices 4) the functionality of the enterprise system 6. For example, the device 8a can be a server for accessing a first application, the device 8b can be another device used by a developer to implement changes to a platform, etc.

Similar to devices 4, the devices 8 can be realized via one or more of (but are not limited to) legacy hardware such as a mainframe, a server, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, and any additional or alternate computing device, and may be operable to transmit and receive data across communication networks such as the communication network 14 shown by way of example in FIG. 1. In example embodiments, some aspects of device 8 can be realized virtually. That is, a first hardware configuration (e.g., a mainframe) can be used to generate virtual machines that mimic the functionality of having separate hardware resources to instantiate a separate device 8.

At least some of devices 4, or some of devices 8, or some of devices 4, 8 can access and proposed changes to a platform utilized by the enterprise system 6. For example, the system 6 can include instances of third party software (not shown), such as Salesforce™ and nCino™ to manage at least some operations of the enterprise. These platforms can have established objects or other data structures, and the devices can be used to customize or generate new objects or data structures that are based on the established objects or data structures. For example, the devices can submit a Salesforce Object Query Language (SOQL) query to change features in a product object of a Salesforce™ platform.

In example embodiments, some of the functionality of the enterprise system 6, or devices 4, 8, or the aforementioned platforms is implemented by remote computing resources 12. The remote computing resources 12 (hereinafter referred to simply as computing resources 12) include resources which are stored or managed by a party other than operator of the enterprise system 6 and are used by, or available to, the enterprise system 6. For example, the computing resources 12 can include cloud-based storage services (e.g., database(s) 12b). These storage services can store objects used by platforms employed by platforms used by the third-party systems. For example, the database(s) 12b can store object definitions, such as in the form of a bitbucket that includes the definitions of objects, or related data files (e.g., data interchange format data files, including in a JSON format).

In at least some example embodiments, the computing resources 12 include one or more tools 12a developed or hosted by the external party (e.g., which can include the aforementioned platforms and related tools), or tools for interacting with the computing resources 12, etc. The computing resources 12 can also include hardware resources (e.g., the shown hardware 12c), such as access to processing capability of server devices (e.g., cloud computing), and so forth.

The computing resources 12 can host two or more environments 10 (alternatively referred to as sandboxes), including the shown environments 10a, 10b to 10n. These environments can be prepopulated or facilitated with access to the computing resources 12 to enable development of certain software products for the enterprise 6. For example, the environment 10a can be populated with object definitions from the database 12b, or queries to enable manipulating the object definitions, etc. The environment 10a can be provided with a share of computing hardware 12c and can be part of a development pipeline in generating new products for use within the enterprise.

Components of the environment 2 can be connected by a communications network 14 to one or more other components of the computing environment 2. In at least some example embodiments, all the components shown in FIG. 1 are within the enterprise system 6, and the communication network 14 is an enterprise-maintained network.

Communication network 14 may include a telephone network, cellular, and/or data communication network to connect distinct types of client devices. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), Wi-Fi or other similar wireless network, and a private and/or public wide area network (e.g., the Internet). The communication network 14 may not be required to provide connectivity within the enterprise system 6 or the computing resources 12, or between devices 4, wherein an internal or other shared network provides the necessary communications infrastructure.

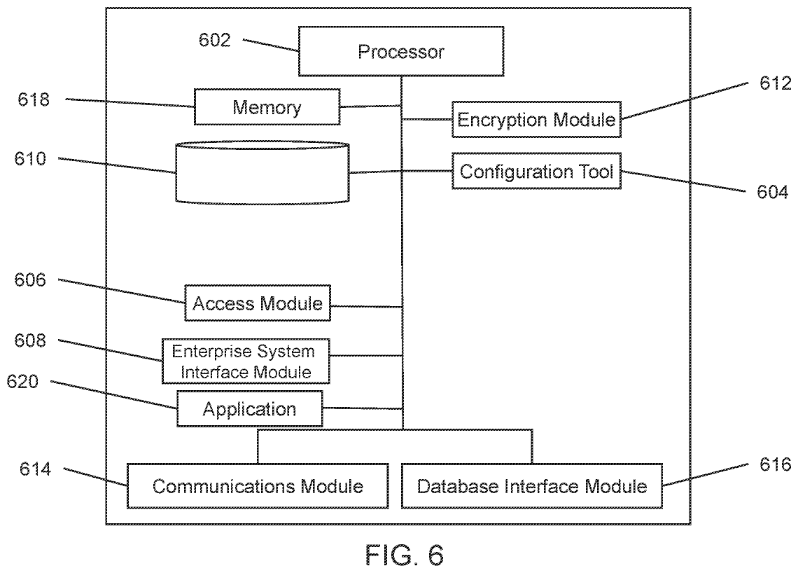

The computing environment 2 can also include a cryptographic server or module (e.g., encryption module 612 of FIG. 6) for performing cryptographic operations and providing cryptographic services (e.g., authentication (via digital signatures), data protection (via encryption), etc.) to provide a secure interaction channel and interaction session, etc. The cryptographic module can be implemented within the enterprise system 6, or the computing resources 12, or external to the aforementioned systems, or some combination thereof. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public, and private keys in a PKI), and perform other cryptographic operations that are required or desired for particular applications carried out by the enterprise system 6 or device 4. The cryptographic server may be used to protect data within the computing environment 2 (e.g., including data stored in database(s) 12B) by way of encryption for data protection, digital signatures or message digests for data integrity, and by using digital certificates to authenticate the identity of the users and entity devices with which the enterprise system 6, computing resources 12, or the device 4 communicates, to inhibit data breaches by adversaries. It can be appreciated that various cryptographic mechanisms and protocols can be chosen and implemented to suit the constraints and requirements of the computing environment 2, as is known in the art.

The enterprise system 6 can be understood to encompass the whole of the enterprise, a subset of a wider enterprise system (not shown), such as a system serving a subsidiary or a system for a particular branch or team of the enterprise (e.g., a resource migration division of the enterprise). In at least one example embodiment, the enterprise system 6 is a financial institution system (e.g., a commercial bank) that provides financial services accounts to users and processes financial transactions associated with those financial service accounts. Such a financial institution system may provide its customers with various browser-based and mobile applications, e.g., for mobile banking, mobile investing, mortgage management, etc. Financial institutions can be responsible for vast amounts of data and have vast amounts of existing records. To provide applications based on that data, effective anonymization schemes are required.

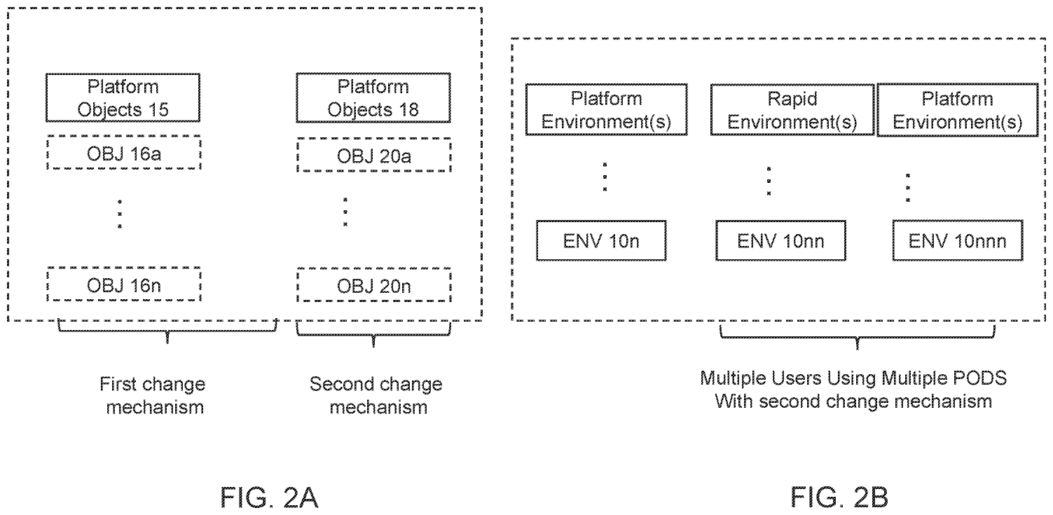

Referring now to FIGS. 2A, 2B, diagrams illustrating existing approaches to managing multi-user development processes systems are shown. As shown in FIG. 2A, an enterprise development environment can include a first set of objects (shown as objects 16a to 16n, but referred to as objects 16 for ease of reference) for a first platform 15 (e.g., Salesforce™), and another, or second, set of objects (shown as objects 20a to 20n. but referred to as objects 20 for ease of reference) for a second platform 18 (e.g., nCino™).

The different platforms 15 and 18 can implement different change mechanisms that can impact the objects 16, 20, or the same change mechanism. For example, the first set of objects 16 can be customized using APEX code and configuration changes or metadata. The second set of objects 20 can be customized using record-based configurations or SOQL queries. The SOQL queries can end up in multiple datafiles (e.g., JSON files) that are submitted to make changes to the same object(s) 20 (or, in at least some example embodiments, objects 16). Record based configurations can be used to customize objects (e.g., objects 20), for example in instances where a customized instance of a user interface (UI) object is needed (a different UI feature is required for a particular use case), or a customized form template is required (e.g., a new application template), etc.

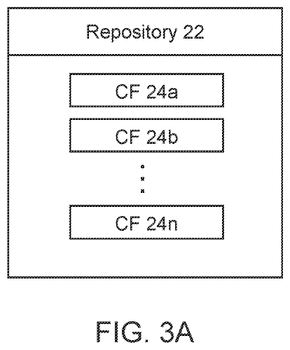

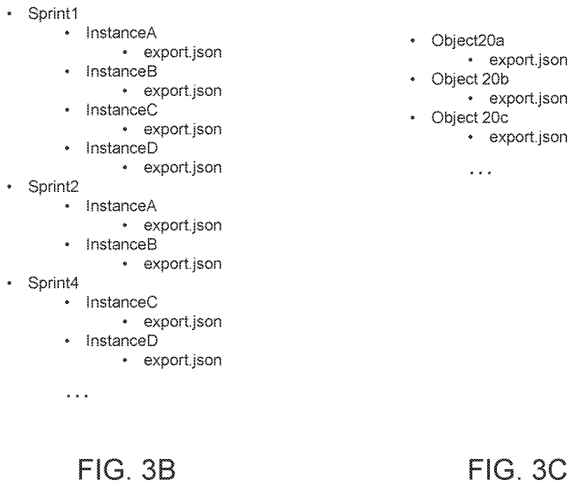

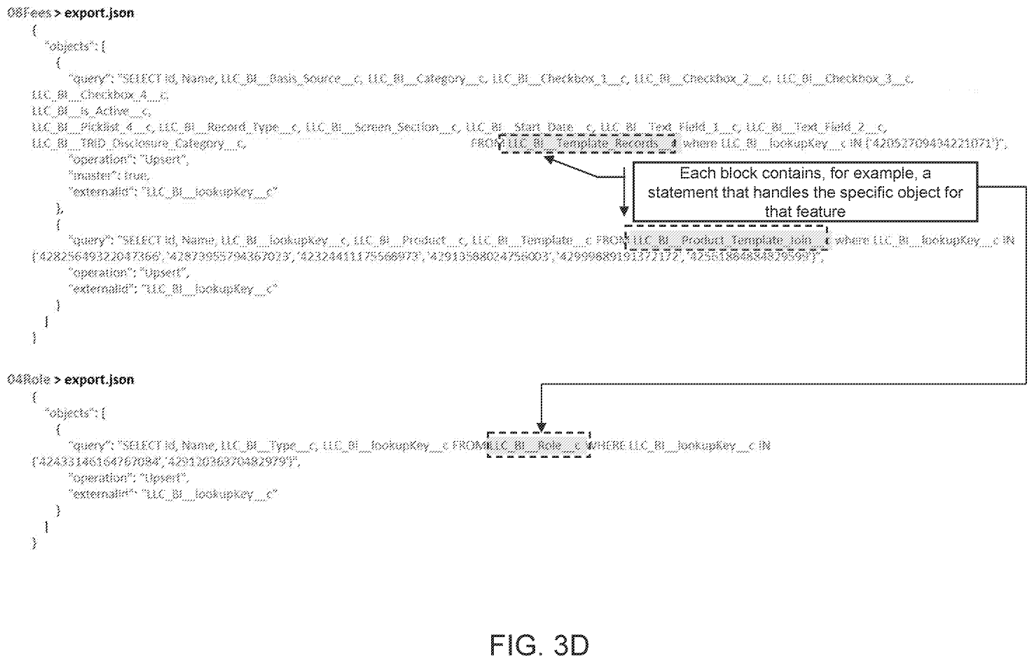

In FIG. 2B, the disparate nature of existing development environments is shown. The different platforms can have assigned environments 10, as shown, and each environment can propose a change to existing objects. As a result, a plurality of data files can be generated to update the objects (e.g., as shown in FIG. 3B, via the shown export .json files), and the different data files from the different environments 10 can be at the very least conflicting, or altogether incompatible.

As disclosed herein, and as shown via example in FIG. 3A, a data interchange format can be developed which limits the number of objects available to the platform(s) 15, 18 to the number of functionalities of the platform(s). The data interchange format can be realized via a definitions repository 22, storing configuration files 24 (shown illustratively as configuration files 24a, 24b . . . 24n) corresponding to the functionality of the platform(s). For example, in the context of commercial banking credit software such as nCino™, the configuration files can include files that define a UI functionality, a destructive functionality, a product category functionality, object, a document functionality, a role functionality, a translation functionality, a document manager functionality, a connection functionality, a fees functionality, a covenant functionality, a collateral functionality, a field map functionality, a policy exception template functionality, and a form template functionality.

The configuration files 24 are structured to be object oriented and feature based. That is, each of the platform(s) objects has a single location (e.g., a JSON file of the repository 22) where it can be altered. The number of features within an object can be limited, to promote cohesion and to restrict variability. The features can be limited to establish a one-to-one relationship between a feature in the platform 15, 18 and an invocation in a corresponding configuration file 24. As mentioned above, and restated for clarity, the number of configuration files 24 can be restricted.

As the configuration files are stored in a repository 22 that is available to the plurality of environments 10, changes (e.g., proposed changes) are shown to multiple environments, enabling users of the different environments 10 to see changes to the configuration files 24, and to realize that their proposed changes can possible be in conflict with the current state of the configuration file 24. For example, an environment 10n can be instantiated with the invention to perform a first change to a UI (e.g., remove certain fields to simplify usability). That environment 10n can be populated with or provided access to the latest version of the relevant configuration files 24 in the definition repository 22 (e.g., only configuration files 24 relevant to the platform the environment 10n pertains to). Users of the environment 10n can see changes to the configuration file 24 related to the UI that are incompatible (e.g., a credit department determines more information to evaluate creditworthiness considering changing events). Therefore, the user of the environment 10n can see that implementing the first change to the UI configuration file 24 will conflict with the existing (or proposed) changes already in the configuration file 24. As a result, conflicts to proposed changes become apparent earlier in the development process. In at least some example embodiments, changes to configuration files 24 are propagated in real time to all environments 10, enabling users of those environments to immediately see whether their changes will conflict with changes proposed by other environments.

As a result of the disclosed data structure, the amount of complexity in the system can be limited owing to the limited number of objects (configuration files 24).

A different definition repository can be established for different platforms 15, 18, or separate definition repositories can be established for different platforms. The configuration files 24, in at least some example embodiments, can be JSON files. The JSON configuration files 24 can, for example, contain SOQL statements that the environments 10 can develop to customize the platforms 15, 18 functionalities. FIG. 3D shows an example of the types of SOQL queries, based on the example objects discussed above.

The repository 22 can be updated real time, or periodically, such as after every successful deployment cycle, wherein the deployment cycle results in updates of any one of the configuration files 24, or on demand, etc.

Referring now to FIGS. 3B and 3C, diagrams showing the difference between existing approaches and the proposed approach are shown. In FIG. 3B, a plurality of data files (shown illustratively as the export .json files) are present, and each of the files can impact one or more objects in the platforms 15, 18. The datafiles of FIG. 3B can be generated in different environments, by different users, etc. Different datafiles of FIG. 3B can impact the same objects 16, 20, causing conflicts in the development process.

In FIG. 3C, an arrangement according to the disclosure is shown. In FIG. 3C, each object has only one associated data file (the shown export .json). Therefore, if developers intend to submit changes to the existing functionality, they are forced to do so via the dedicated object data file.

As shown in FIG. 3C, the number of data files required to be consulted to understand the full scope of changes to an object is limited to one. Features that require changes are outlined in the respective data file.

The approach can enable federated and version-controlled processes, whereby with each development cycle, all changes introduced are apparent, and implemented changes are updated in the respective data files 24 used to populate the respective environments.

With the proposed approach, the likelihood of so-called accidental overwrites (e.g., different parties overriding one another through certain auto-merging rules of the platform) can decrease dramatically, given that all users capable of making changes at least start out with the same understanding of what changes have been implemented.

The proposed approach can also be beneficial from an automated development perspective; conflict issues are discovered early in the process, and the remainder of the testing process (e.g., quality control, validation) can proceed quicker. Relatedly, the increased ease of automation can increase the velocity of development; with common conflicts issues being resolved before submission for automated testing, it is less likely that the automated testing will have to be restarted. For example, with the proposed approaches, development durations of under two (2) hours have been achieved, as compared to previous development durations that exceeded ten (10) hours. In addition, the automated processes can be simplified, and more repeatable given the sole source of changes.

In addition, by having all developers in a development cycle submit changes to an object via a single data file 24, sequential development can be enforced. That is, developers will no longer be able to impact changes to an object with another data file (e.g., FIG. 3B) unknown to the existing process to implement changes to that object. As a result, changes cannot be overridden due to the development queue of different files which can impact the same objects (e.g., the JSON data files are sequential, and hence data dependency compliant).

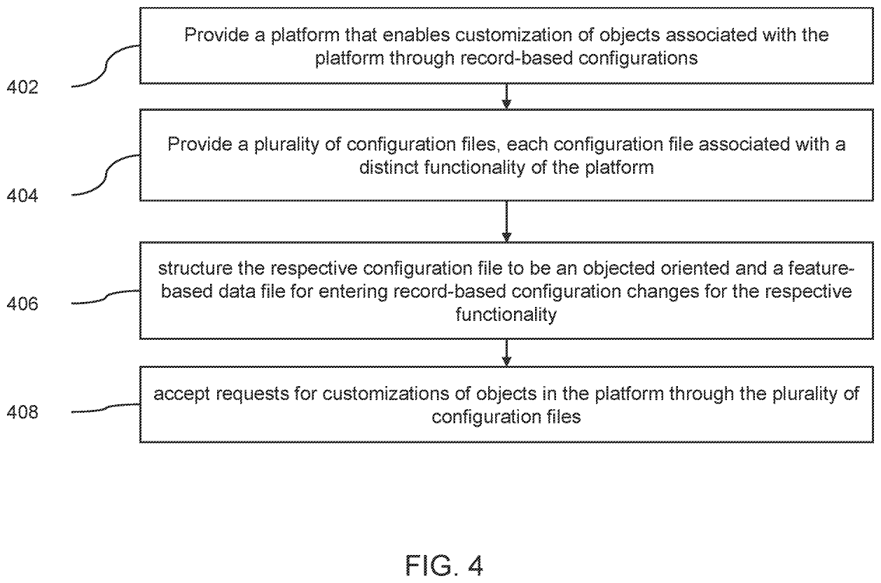

Referring now to FIG. 4, a flow diagram of an example embodiment of computer executable instructions for implementing a method for managing multi-user development systems is shown. It is understood that reference to the preceding figures to discuss FIG. 4 are illustrative, and not intended to limit FIG. 4.

At block 402, a platform that enables customization of objects associated with the platform through record-based configurations is provided. For example, the platform can be nCino™.

At block 404, a plurality of configuration files (e.g., configuration files 24) are provided. Each configuration file is associated with the functionality of the platform.

At block 406, each configuration file is structured to be an object oriented and a feature-based data file for entering record-based configuration changes for the respective functionality. Structuring can include pre-populating the configuration file with a plurality of objects that are associated with objects of the platform 15, 18. A more detailed example of a configuration file is shown in FIG. 3D. The SOQL statements shown therein can handle a specific object for a corresponding feature, as shown.

At block 408, requests for customizations of objects of the platform are accepted through the plurality of configuration files. For example, the development process can be configured so that only customizations that arise from the configuration files 24 are accepted, forcing all proposed customizations to occur in the limited number of configuration files 24.

The configuration files of blocks 406 and 408 can be access controlled (as discussed herein), and the executable instructions can include providing access to the plurality of configuration files to a plurality of development environments (e.g., environments 10). The access can be simultaneous (e.g., all edits from the environments 10 have be submitted and are visible to all other environments).

In example embodiments, the plurality of configuration files of block 408 include configuration files for UI functionality or for role definition functionality or product functionality.

The configuration files 24 can be updated. For example, the configuration files can be updated in real time as changes are proposed in different development environments. The configuration files 24 can be updated at the end of successful development cycles, such that changes to the configuration files are accepted, and each new (or updated) environment is populated with a common baseline.

The configuration files 24 can be used as part of an automated development cycle comprising a plurality of stages. For example, the configuration files 24 can be configured as part of a development stage, whereas the validation and the quality control can be automated portions of subsequent development operations based at least in party on the configuration file, to enable rapid automated development.

In at least some example embodiment, users are routed towards submitting requests for customization via the plurality of configuration files. For example, an error can be returned when trying to validate customizations other than via configuration files 24, or a GUI can be used to steer the user to the particular location, etc.

It is understood that variations of the sequences shown in FIG. 4 are contemplated by this disclosure. For example, blocks 404 and 406 can be completed in parallel, or the configuration files can be populated by one set of users and provided in block 404 to a distinct set of users or devices, etc.

Referring now to FIG. 5, an example configuration of a device 4, 8 (hereinafter referred to solely as device 4, for ease of reference) is shown. It can be appreciated that the device 4 shown in FIG. 5 can correspond to an actual device or represent a simulation (e.g., a virtual machine) of such a device 4. The shown device 4 can be an internal device, or an external device. The device 4 can include one or more processors 502, a communications module 514, and a data store 516 (e.g., including configuration files, such as the shown file 520).

The data store 516 can also be used to store data, such as, but not limited to, an IP address or a MAC address that uniquely identifies device 4. The data store 516 may also be used to store data ancillary to transmitting data to the computing environment 2, such as, but not limited to, login credentials, user preferences, cryptographic data (e.g., cryptographic keys), etc.

Communications module 514 enables the device 4 to communicate with one or more other components of the computing environment 2 via a bus or other communication network, such as the communication network 14. The device 4 includes at least one memory 518 or memory device that can include a tangible and non-transitory computer-readable medium having stored therein computer programs, sets of instructions, code, or data to be executed by processor 502. FIG. 5 separately illustrates examples of modules and applications stored in memory 518 on the device 4 and operated by the processor 502. It can be appreciated that any of the modules and applications shown in FIG. 5 may also be hosted externally and be available to the device 4, e.g., via the communications module 514.

In the example embodiment shown in FIG. 5, the device 4 includes a display module 504 for rendering graphical user interfaces (GUIs) and other visual outputs on a display device such as a display screen, and an input module 506 for processing user or other inputs received at the device 4, e.g., via a touchscreen, input button, transceiver, microphone, keyboard, etc. The device 4 may also include one or more applications, such as the shown platform applications 508 to access one or more platforms. For example, the application 508a can be an application of a first platform, such as Salesforce, and the application 508b can be an application of a second record-based configuration platform such as nCino™. In example embodiments, the application 508 can be a web-based application that serves certain data to contractors or enables the device to access the enterprise system 6 or computing resources 12.

The device 4 may include an access control module 510 to control access to the data store 516, or data within the data store 516, or applications 508, etc. For example, the access control module 510 can control access to the different environments or data described herein based on the registered or authenticated users of the device 4 (e.g., which users can read, access, or write with data within the data store 516). In another example, the access control module 510 can be used to control transmission of data within the data store 516.

The uploading module 512 enables the device 4 to, if necessary, interface with the remote computing resources 12, or a subset thereof, to transmit data or requests, etc.

Referring to FIG. 6, an example configuration of server (e.g., a server device 8 of the enterprise system, or a server device of computing resources 12), is shown. It can be appreciated that the server shown in FIG. 6 can correspond to an actual device, or represent a simulation of the functionality of a server, or represent a configuration of multiple servers cooperating as a mainframe, etc. The server can include one or more processors 602, a communications module 614, and a data store 610 (e.g., for storing the modules, access controls, maintaining stages, etc.), and a database interface module 616.

Communications module 614 enables the server to communicate with one or more other components of the remote computing resources 12 or the enterprise system 6 via a bus or other communication network, such as the communication network 14. The server includes at least one memory 618 or memory device that can include a tangible and non-transitory computer-readable medium having stored therein computer programs, sets of instructions, code, or data to be executed by processor 602. FIG. 6 separately illustrates examples of modules and applications stored in memory 618 on the server and operated by the processor 602. It can be appreciated that any of the modules and applications shown in FIG. 6 may also be hosted externally and be available to the server, e.g., via the communications module 614.

In the example embodiment shown in FIG. 6, the server includes configuration tool 604 that is used to generate configuration files 24, and/or to control processes to ensure that the configuration files 24 are adhered to. For example, the configuration tool 604 can be used to control automated testing such that the automation requires changes to objects of a platform to be submitted via the configuration file.

The server can include an access control module 606, similar to the access control module 510. The access control module 606 can control access to modules, platforms, etc., and control which users are able to initiate operation of the configuration tool 604, etc.

The server may also include an enterprise system interface module 608 whose purpose is to facilitate communication with the enterprise system 6.

The server can include an encryption module 612 to encrypt data, or to encrypt communications between environments, etc. The encryption module 612 can encrypt data in a variety of manners. In at least some example embodiments, data is encrypted by the encryption module 612 in cooperation with a complementary encryption module on the device 4 or on-premises (not shown).

The database interface module 616 facilitates communication with databases used to store the data (e.g., data store 610). For example, the database interface module 616 can be used to move data between stages of the computing resources 12. The data store 610 may also be used to store data ancillary to transmitting or receiving data within the computing environment 2, such as, but not limited to, login credentials, user preferences, cryptographic data (e.g., cryptographic keys), etc.

The server can also include a plurality of applications to interact with platforms, shown illustratively as the single application 620.

It will be appreciated that only certain modules, applications, tools, and engines are shown in FIGS. 5, and 6 for ease of illustration and various other components would be provided and utilized by the device 4, enterprise system 6, and/or the remote computing resources 12, as is known in the art.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of any of the servers or other devices in the computing environment 2, or accessible or connectable thereto. Any application or module herein described may be implemented using computer readable/executable instructions that may be stored or otherwise held by such computer readable media.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A device for managing multi-user development systems, the device comprising:
a processor;
a communications module coupled to the processor; and
a memory coupled to the processor, the memory storing computer executable instructions that when executed by the processor cause the processor to:
provide a platform that enables customization of objects associated with the platform through record based configurations;
provide a plurality of configuration files, each configuration file associated with a distinct functionality of the platform;
for each configuration file of the plurality of the configuration files:
structure the respective configuration file to be an objected oriented and a feature-based data file for entering record based configuration changes for the respective functionality; and
accept requests for customizations of objects in the platform through the plurality of configuration files.

2. The device of claim 1, wherein the computer executable instructions cause the processor to:
provide access to the plurality of configuration files to a plurality of development environments.

3. The device of claim 2, wherein the access provided to the plurality of development environments is simultaneous.

4. The device of claim 1, wherein the computer executable instructions cause the processor to:
populate new development environments with the plurality of configuration files.

5. The device of claim 1, wherein the plurality of configuration files are in a JSON format.

6. The device of claim 5, wherein the JSON format is structured such that configuration files utilize SOQL statements to handle a specific object for a corresponding feature.

7. The device of claim 1, wherein the computer executable instructions cause the processor to:
update the plurality of configuration files in response to completion of a development cycle.

8. The device of claim 1, wherein the computer executable instructions cause the processor to:
route requests to customize objects of the platform to the plurality of configuration files.

9. The device of claim 1, wherein the plurality of configuration files comprise configuration files for user interface functionality or for role definition functionality or product functionality.

10. The device of claim 1, wherein the computer executable instructions cause the processor to:
automatically perform one or more development operations in response to receiving requests for customizations of objects in the platform through the plurality of configuration files.

11. A method for managing multi-user development systems, the method comprising:
providing a platform that enables customization of objects associated with the platform through record based configurations;
providing a plurality of configuration files, each configuration file associated with a distinct functionality of the platform;
for each configuration file of the plurality of the configuration files:
structuring the respective configuration file to be an objected oriented and a feature-based data file for entering record based configuration changes for the respective functionality; and
accepting requests for customizations of objects in the platform through the plurality of configuration files.

12. The method of claim 11, comprising:
providing access to the plurality of configuration files to a plurality of development environments.

13. The method of claim 12, wherein the access provided to the plurality of development environments is simultaneous.

14. The method of claim 11, further comprising:
populating new development environments with the plurality of configuration files.

15. The method of claim 11, wherein the plurality of configuration files are in a JSON format.

16. The method of claim 15, wherein the JSON format is structured such that configuration files utilize SOQL statements to handle a specific object for a corresponding feature.

17. The method of claim 11, further comprising:
updating the plurality of configuration files in response to completion of a development cycle.

18. The method of claim 11, further comprising:
routing requests to customize objects of the platform to the plurality of configuration files.

19. The method of claim 11, wherein the plurality of configuration files comprise configuration files for user interface functionality or for role definition functionality or product functionality.

20. A non-transitory computer readable medium for managing multi-user development systems, the computer readable medium comprising computer executable instructions for:
providing a platform that enables customization of objects associated with the platform through record based configurations;
providing a plurality of configuration files, each configuration file associated with a distinct functionality of the platform;
for each configuration file of the plurality of the configuration files:
structuring the respective configuration file to be an objected oriented and a feature-based data file for entering record based configuration changes for the respective functionality; and
accepting requests for customizations of objects in the platform through the plurality of configuration files.
